(19) United States
(12) Patent Application Publication
(10) Pub. No.: US 2005/0103344 A1
(43) Pub. Date: May 19, 2005

(54) Mask ear loop holding device

(75) Inventor: Yung-Chu Cheng, Taipei (TW)

Correspondence Address: TROXELL LAW OFFICE PLLC, SUITE 1404, 5205 LEESBURG PIKE, FALLS CHURCH, VA, 22041, US

(73) Assignee: Center Healthcare Technology Co., Ltd.

(21) Appl. No.: 10/950,527

(22) Filed: Sep. 28, 2004

(30) Foreign Application Priority Data
Nov. 14, 2003 (TW) 092220266

(51) Int. Cl. A62B 18/08

(52) U.S. Cl. 128/206.13; 128/206.27; 128/207.11

(57) ABSTRACT

A mask ear loop holding device includes a holding plate provided with at least one loop holder for engaging with two ear loops of a mask worn on a user's face, so as to hold the ear loops to a rear side of the user's head to minimize frictional contact of the ear loops with the user's ears, making the mask more comfortable for wearing.

### FIELD OF THE INVENTION

The present invention relates to a holding device, and more particularly to a mask ear loop holding device capable of avoiding frictional contact of mask ear loops with a user's ears.

### BACKGROUND OF THE INVENTION

In the medical field, various types of protective products from gloves, masks to protective coats have been provided in an attempt to achieve complete protection of human against infection by all kinds of eye invisible microbes (such as mites), bacteria, and viruses that exist in human living environments to endanger human health.

It is most important for trained nurses to have the concept of medical protection because they usually have to closely contact with patients over prolonged time in their work and are therefore more possibly infected. A mask is a necessary means in nurses' work to shield their mouth and nose against dangerous factors and reduce the probability of infection. A mask is also needed by workers in highly contaminated working environments to prevent dust, particles, etc. in the air from entering into their respiratory and digestive organs.

The endangering Severe Acute Respiratory Syndrome (SARS) discovered in recent years infects people via patient's spittle that floats in the air or contacts with people. In this condition, a mask is absolutely needed to reduce the possibility of being infected by SARS.

Moreover, the increasingly degraded air quality in our polluted living environment also necessitates the use of a mask to isolate hazardous dust and particles from invading our body. Therefore, a mask has become an inevitable protective product in our life.

However, wearing a mask over a prolonged time would usually discomfort the user because two ear loops of the mask tend to tightly compress a joint of the user's ears and head to cause some side effects, such as headache, dizziness, etc. In the past, people have tried to change the manner of wearing the mask, but not to improve the ear loop type mask.

### SUMMARY OF THE INVENTION

A primary object of the present invention is to provide a mask ear loop holding device that effectively eliminates discomforts from prolonged frictional contact of ear loops of the mask with the user's ears.

To achieve the above and other objects, the mask ear loop holding device of the present invention includes a holding plate provided with at least one loop holder for engaging with two ear loops of a mask worn on a user's face, so as to hold the ear loops to a rear side of the user's head instead of hanging on the ears, making the mask more comfortable for wearing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a mask ear loop holding device according to a first embodiment of the present invention;

FIG. 2 is an exploded perspective view showing a first example of using the mask ear loop holding device of the present invention with a mask;

FIG. 3 shows the use of the mask ear loop holding device of FIG. 1 to hold ear loops of a mask worn on a user's face;

FIG. 4 is a perspective view of a mask ear loop holding device according to a second embodiment of the present invention;

FIG. 5 is a perspective view of a mask ear loop holding device according to a third embodiment of the present invention;

FIG. 6 is a perspective view of a mask ear loop holding device according to a fourth embodiment of the present invention;

FIG. 7 is a perspective view of a mask ear loop holding device according to a fifth embodiment of the present invention;

FIG. 8 shows a second example of using the mask ear loop holding device of the present invention with a mask;

FIG. 9 is a perspective view of a mask ear loop holding device according to a sixth embodiment of the present invention;

FIG. 10 is a perspective view of a mask ear loop holding device according to a seventh embodiment of the present invention;

FIG. 11 shows the use of the mask ear loop holding device of FIG. 9 in a vertical position to hold ear loops of a mask worn on a user's face; and

FIG. 12 shows the use of the mask ear loop holding device of FIG. 9 in a horizontal position to hold ear loops of a mask worn on a user's face.

### DETAILED DESCRIPTION OF THE PREFERRED EMBODIMENTS

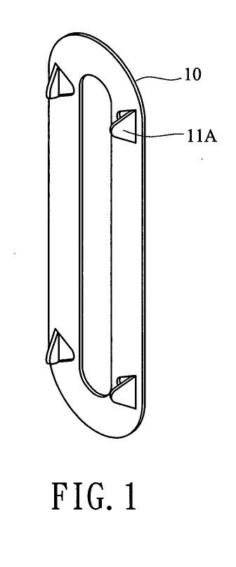

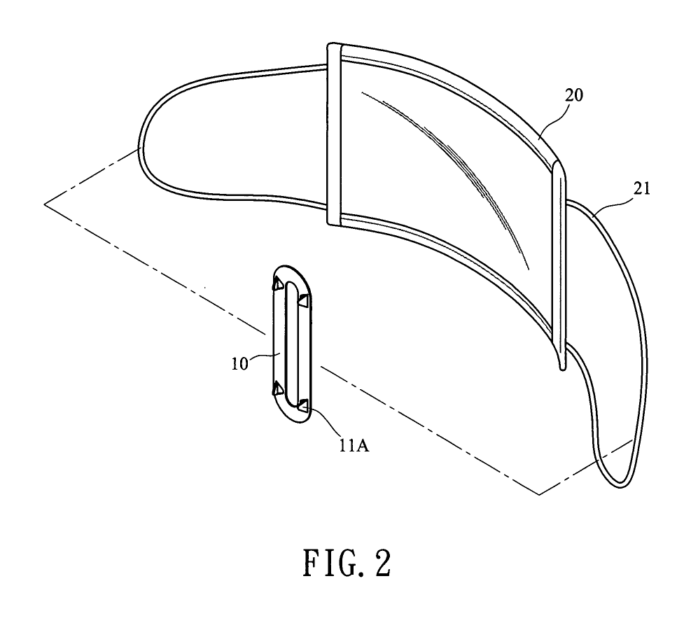

Please refer to FIG. 1 that is a perspective view of a mask ear loop holding device according to a first embodiment of the present invention. As shown, the mask ear loop holding device in the first embodiment of the present mainly includes a holding plate 10 that forms a main body of the device. The holding plate 10 may be, for example, a flat oblong member with an open central area, and has at least one loop holder 11A provided at a predetermined position thereon. The loop holder 11A may be, for example, a flat triangular piece protruded from an outer surface of the holding plate 10. Please refer to FIG. 2. In a first example of using the mask ear loop holding device of the present invention with a mask 20, two ear loops 21 of the mask 20 are separately engaged with the at least one loop holder 11A on the holding plate 10.

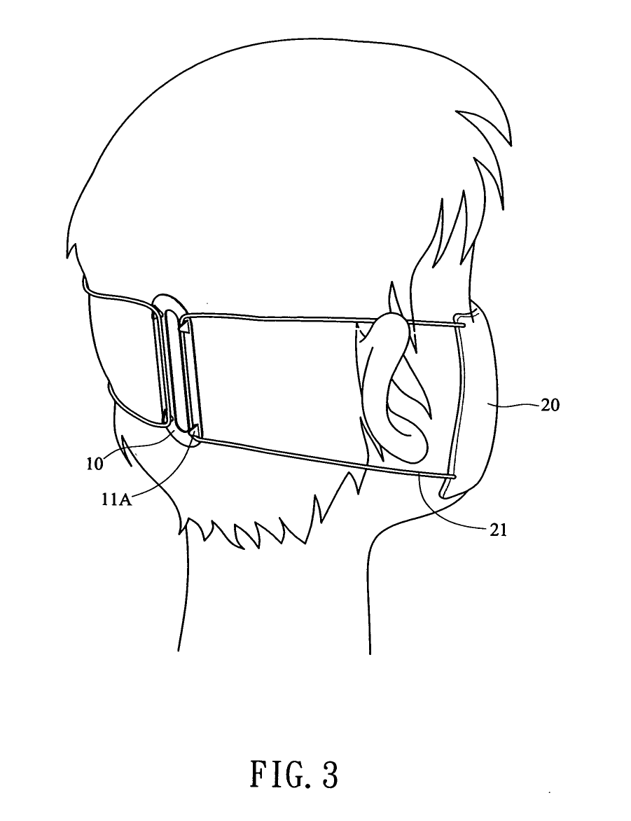

Please refer to FIG. 3. When a user wants to wear the mask 20, simply pulls the ear loops 21 to pass two ears and engage with or hook to the at least one loop holder 11A on the holding plate 10 of the device of the present invention, which is located at a lower rear portion of the user's head. Since the ear loops 21 are not directly hooked to the user's ears, they do not in frictional contact with the ears. Moreover, the holding plate 10 has a vertical length larger than a joint of a helix of the user's ear and the user's head to further reduce the possibility of frictional contact of the ear loops 21 with the user's ears.

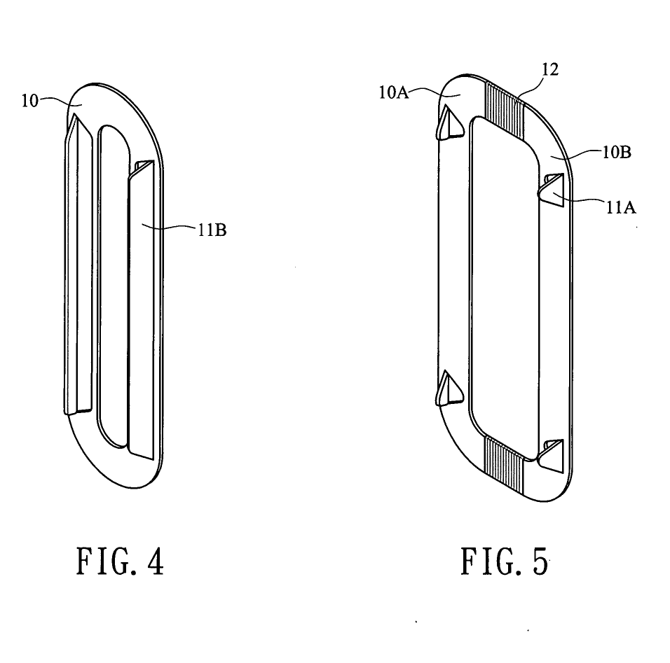

FIG. 4 shows a mask ear loop holding device according to a second embodiment of the present invention. In the second embodiment, the device includes a holding plate 10 having a loop holder 11B in the form of a flat long piece protruded from an outer surface of each longitudinal side of the holding plate 10 for an ear loop of a mask to engage therewith. With the two long loop holders 11B, the mask 20 could be more conveniently connected to the mask ear loop holding device of the present invention.

FIG. 5 shows a mask ear loop holding device according to a third embodiment of the present invention. In the third embodiment, the device includes a left holding plate 10A and a right holding plate 10B integrally connected to each other via an elastic section 12, and a plurality of loop holders 11A in the form of a flat triangular piece protruded from an outer surface of the left and right holding plates 10A, 10B. The elastic section 12 provides proper sideward extension of the holding plates 10A, 10B for the mask 20 engaged therewith to have more flexibility to meet different head sizes. To achieve this function, the elastic section 212 is made of an elastic rubber material.

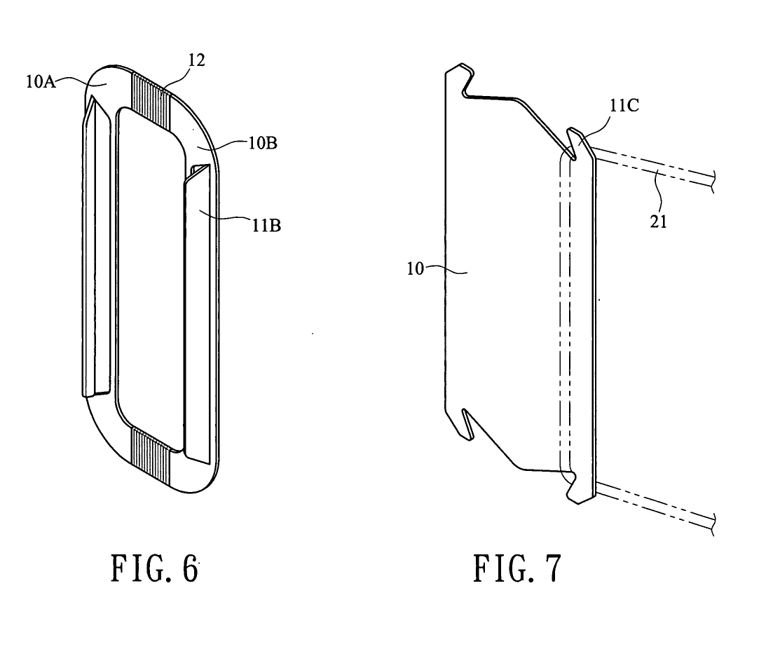

FIG. 6 shows a mask ear loop holding device according to a fourth embodiment of the present invention. The fourth embodiment is similar to the third embodiment, except that the holding plate 10A, 10B are provided with loop holders 11B in the form of a flat long piece.

FIG. 7 shows a mask ear loop holding device according to a fifth embodiment of the present invention. The mask ear loop holding device in the fifth embodiment includes a holding plate 10 being provided at four corners with a loop holding section 11C each to maximize a vertical distance between the two loop holding sections 11C at the same longitudinal side of the holding plate 10, so that the ear loops 21 do not frictionally contact with the user's ears at all.

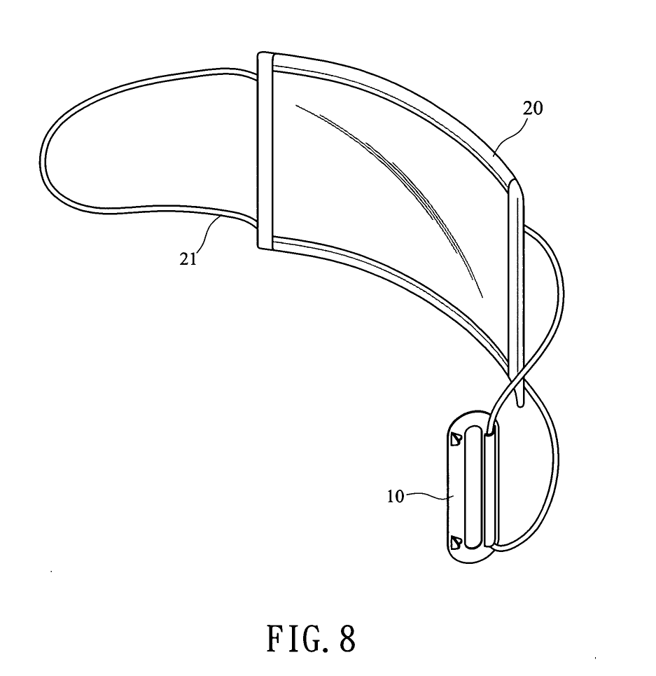

FIG. 8 shows a second example of using the present invention with a mask 20. In this example of use, the mask ear loop holding device is directly connected at one longitudinal side to one ear loop 21 of the mask 20 to form a part of the mask 20, and provided at the other longitudinal side with at least one loop holder 11A for engaging with the other ear loop 21 of the mask 20, so that the holding plate 10 is located at a rear portion of the user's head.

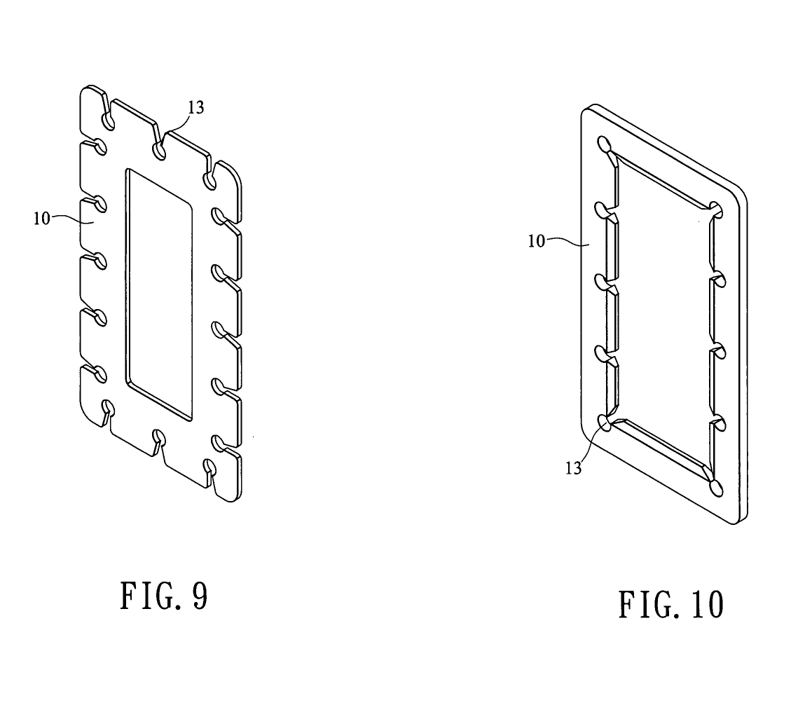

For the present invention to adapt to more different head sizes, a sixth embodiment thereof is shown in FIG. 9. In the sixth embodiment, the device of the present invention includes a substantially flat rectangular holding plate 10 having an open central area. A plurality of notches 13 are spaced along an outer periphery of the holding plate 10 for engaging with and locating the ear loops 21 of the mask 20 in place.

FIG. 10 shows a seventh embodiment of the present invention that is similar to the sixth embodiment, except that the notches 13 are spaced along an inner periphery of the open central area of the holding plate 10 to provide the same good effect of holding the ear loops 21 of the mask 20 in place.

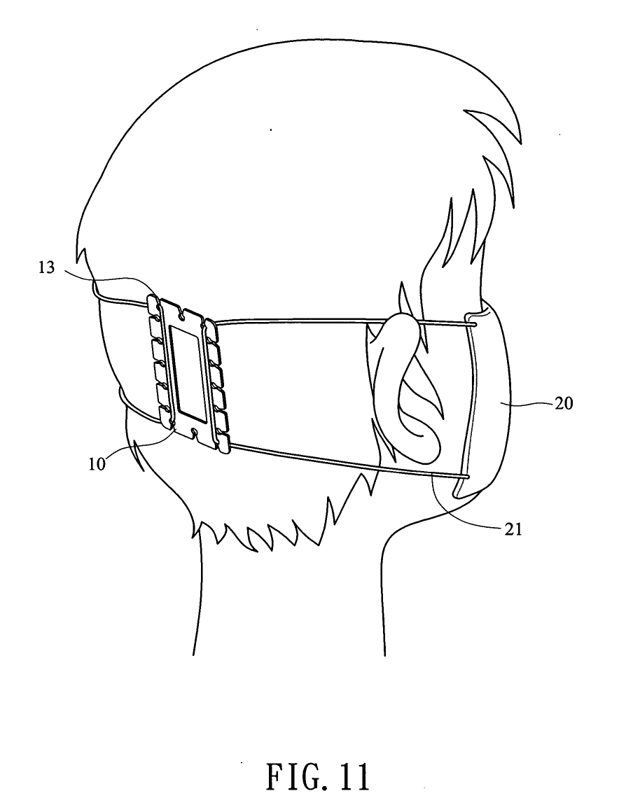

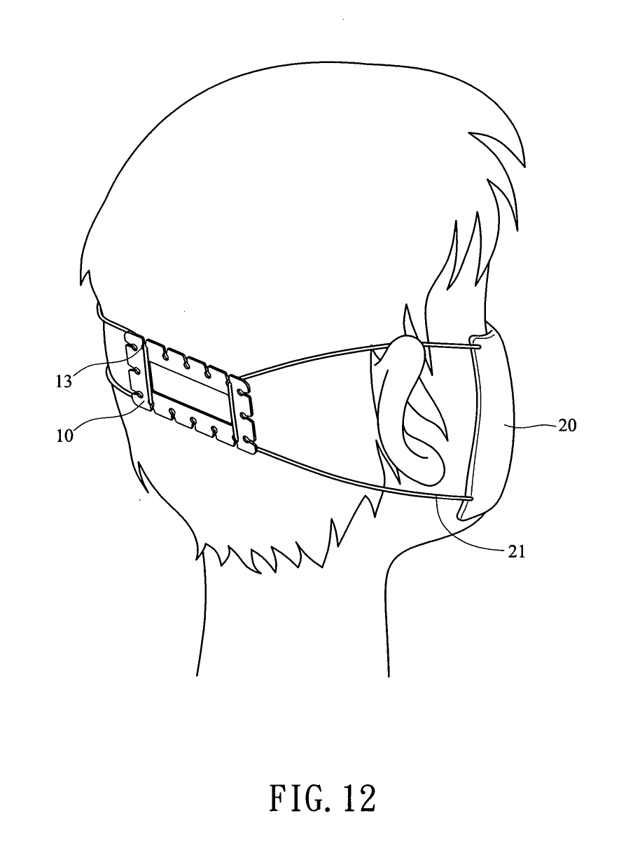

FIG. 11 shows the use of the mask ear loop holding device of FIG. 9 in a vertical position to hold ear loops 21 of a mask 20 worn on a user's face. A user may freely select the notches 13 best for comfortably holding the mask 20 on the face. In other words, the notches 13 spaced on the outer periphery of the holding plate 10 serve as means for fine adjustment. For instance, as shown in FIG. 11, the ear loops 21 of the mask 20 are engaged with the notches 13 located at outermost positions on the holding plate 10 to avoid frictional contact of the ear loops 21 with the user's ears and tight binding of the whole mask 20 around the user's head. On the other hand, when the user has a small head size or prefer to a somewhat tight mask, notches 13 closer to inner positions of the holding plate 10 may be selected to engage with the ear loops 21. As can be seen from FIG. 12, the mask ear loop holding device of FIG. 9 may also be horizontally connected to the mask 20, so that the user has more choices in adjusting an tension of the ear loops 21 to make the mask 20 more comfortable for wear.

The present invention has been described with some preferred embodiments thereof and it is understood that many changes and modifications in the described embodiments can be carried out without departing from the scope and the spirit of the invention that is intended to be limited only by the appended claims.

1. A mask ear loop holding device for holding two ear loops of a mask at a rear side of a user's head, comprising a holding plate having at least one loop holder provided thereon, such that said ear loops of said mask could be engaged with selected ones of said at least one loop holder when said mask is worn on a user's face.

2. The mask ear loop holding device as claimed in claim 1, wherein said holding plate has a vertical length larger than a joint of human helix and head.

3. The mask ear loop holding device as claimed in claim 1, wherein said holding plate has an open central area.

4. A mask ear loop holding device for holding two ear loops of a mask at a rear side of a user's head, comprising:
a left holding plate provided with at least one loop holder for engaging with one of said two ear loops of said mask;
a right holding plate provided with at least one loop holder for engaging with the other one of said two ear loops of said mask; and
at least one elastic section for elastically connecting said left holding plate to said right holding plate.

5. The mask ear loop holding device as claimed in claim 4, wherein said left holding plate has a vertical length larger than a joint of human helix and head.

6. The mask ear loop holding device as claimed in claim 4, wherein said right holding plate has a vertical length larger than a joint of human helix and head.

7. The mask ear loop holding device as claimed in claim 4, wherein said elastic section is made of an elastic rubber material.

8. A mask with ear loop holding device, comprising a mask portion and two ear loops; said mask being characterized in that one of said two ear loops has a holding plate connected thereto; and that said holding plate is provided with at least one loop holder for the other one of said two ear loops to engage therewith, so as to hold said two ear loops of said mask to a rear side of a user's head.

9. The mask ear loop holding device as claimed in claim 8, wherein said holding plate has a vertical length larger than a joint of human helix and head.

10. A mask ear loop holding device for holding two ear loops of a mask at a rear side of a user's head, comprising a holding plate having a plurality of notches provided at predetermined positions thereon, and said ear loops are engaged with selected ones of said notches to connect said mask to said holding plate.

11. The mask ear loop holding device as claimed in claim 10, wherein said notches are spaced along an outer periphery of said holding plate.

12. The mask ear loop holding device as claimed in claim 10, wherein said holding plate has an open central area, and said notches being spaced along an inner periphery of said open central area.
